(19) United States
(12) Patent Application Publication
(10) Pub. No.: US 2013/0233443 A1
(43) Pub. Date: Sep. 12, 2013

(54) Water Diverter/Collector System

(71) Applicant: Bret Allen Kuehneman, Brookfield, WI (US)

(72) Inventor: Bret Allen Kuehneman, Brookfield, WI (US)

(73) Assignee: Bret Allen Kuehneman, Brookfield, WI (US)

(21) Appl. No.: 13/778,187

(22) Filed: Feb. 27, 2013

Related U.S. Application Data
(60) Provisional application No. 61/605,670, filed on Mar. 1, 2012.

(51) Int. Cl. F16L 55/24

(52) U.S. Cl. CPC F16L 55/24
USPC 141/69

(57) ABSTRACT

The collector housing (1) assembles the cover (2), for collection to outside water applications. An intake feature (3) integrates into the cover opening (2). The exit port (4) connects the water exit (5), and the housing (1).

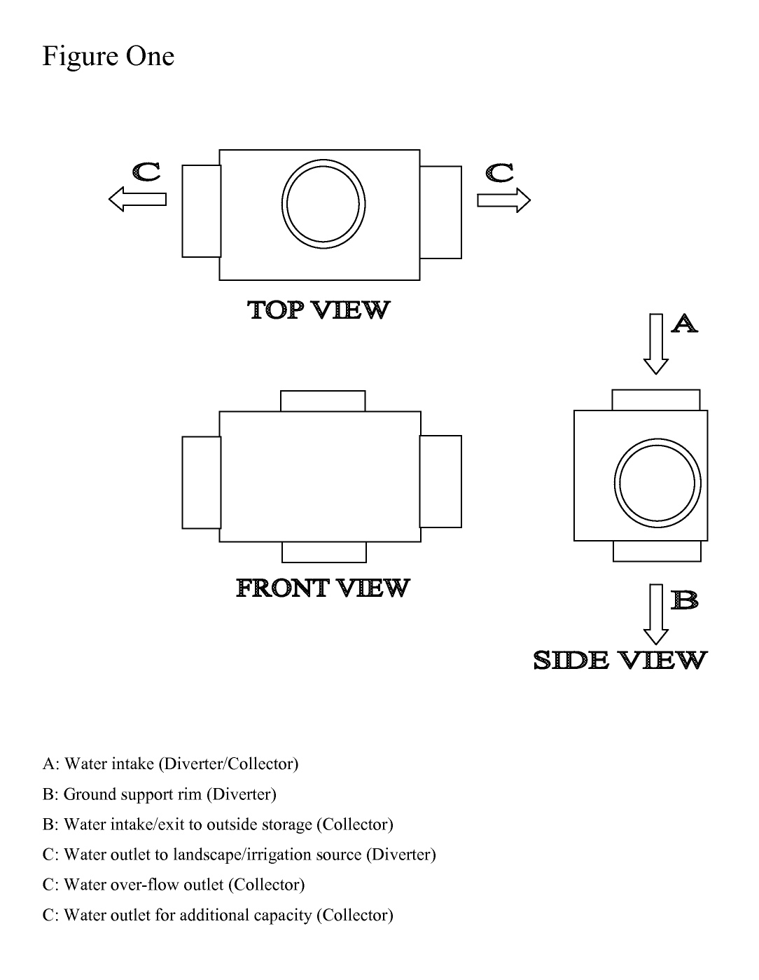

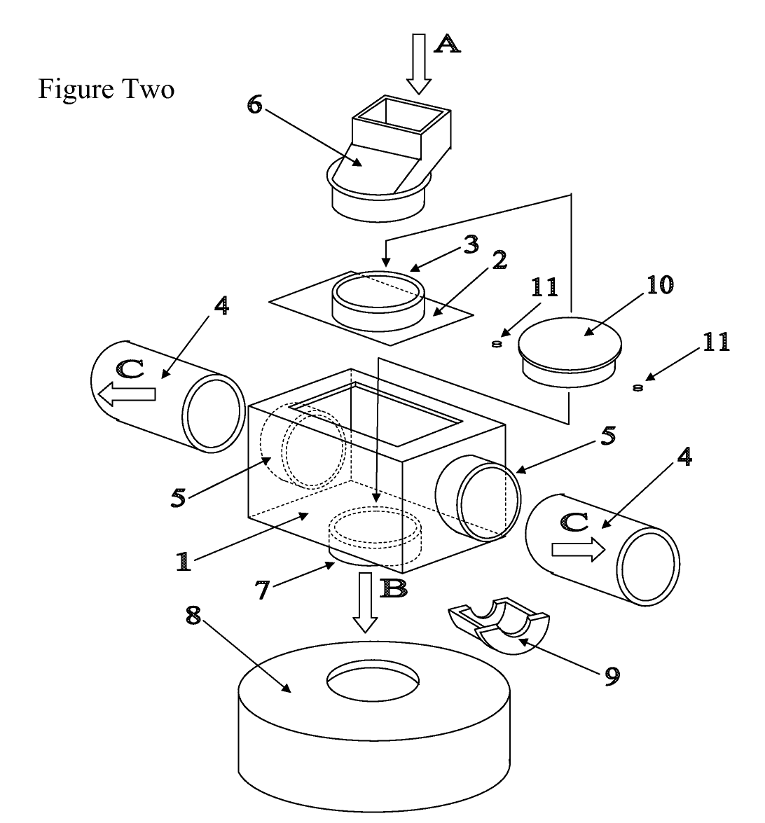

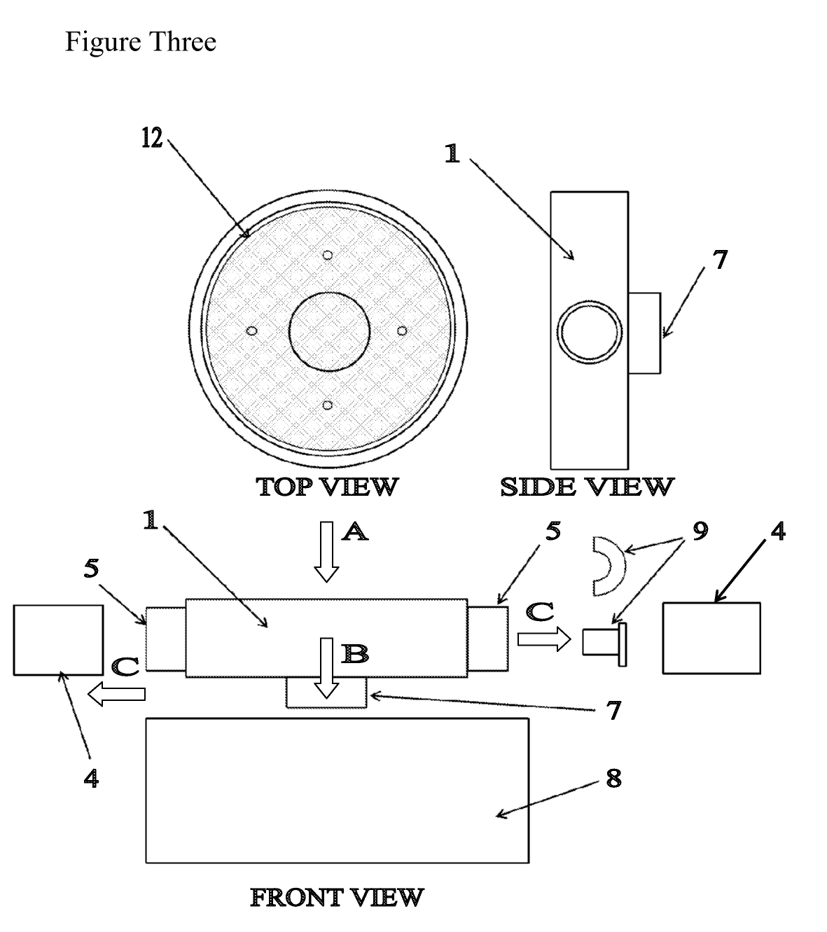

The assembled housing (1) and cover (2) positions to the water intake. Port connectors (4) assemble to the exit ports (5), of the housing (1). The intake feature (3) of the cover (2) assembles to an outside connector (6) attaching the intake source.

The bottom port (7) of the housing (1) assembles the water source (8). The cover (2) assembles the housing body (1). Port connections (4) assemble the water exit port (5), of the housing (1). Intake ports (3) of the cover (2) assemble the outside connector (6) from the intake source.

### BACKGROUND OF THE INVENTION

Several types of water diverter/collector systems are known in the art. U.S. Pat. No. 5,730,179 to Taylor a rainwater collection and distribution apparatus includes a tank which includes a water entry portion, a water exit portion, and a water containment portion located between the water entry portion and the water exit portion. Also U.S. Pat. No. 6,941,702 to Abrams a rainwater collection and dispensation system that includes a gutter being adapted to a building structure; and also includes a tank support member being adapted to rest upon a ground and being disposed beneath a portion of the gutter; and further includes a tank being securely supported upon the tank support member; and also includes a drainage spout interconnecting the gutter and the tank for draining rainwater from the gutter into the tank; and further includes a rainwater dispensing assembly including an overflow pipe member being disposed through a wall of the tank for draining rainwater from the tank.

Rain water storage devices are known such as U.S. Pat. No. 6,553,723 to Alcorn an A rainwater collection and storage system to collect and store roof water, the system comprising of water collection slots adapted to extend through roof sheets and spaced from the edge of the roof, collection means located below the roof sheets to collect the water from at least some of the slots, and at least one tank wall to store the collected water, the at least one tank wall having a narrow section to approximate a wall thickness, and extending from a ground floor to adjacent the roof. Also U.S. Pat. No. 7,025,879 to Ticknor a rainwater collection apparatus comprising of a reservoir storing rainwater; an intake attachable to a said reservoir, said intake having a screen for segregating debris from said reservoir; a first outlet for egress of stored rainwater; and a second outlet for egress of collected rainwater wherein said second outlet is operatively coupled with a pump for exporting water.

Rain water collection assemblies are also known. U.S. Pat. No. 7,395,633 to Baeta a rainwater collection and diverging system includes a housing that has a bottom wall and a perimeter wall. A door is positioned in the bottom wall. A hinge couples the door to the bottom wall and a biasing member is attached to the door and biases the door in a closed position. Also U.S. Pat. No. 5,735,304 to Chumley collection boxes and method for distributing run-off water utilize upright sides with an open top for positioning at ground level with an entrance connection for receiving an underground pipe, a bottom communicates with a drainage opening for avoiding standing water.

### SUMMARY OF THE INVENTION

The water diverter/collector system is a mechanical assembled product holding a variety of adapters and connecting devices for water diversion and water collection applications. The product is a single-based product/system for both the water diversion and water collection applications, with detailed design/manufactured modifications specifically for the water collection application.

This single-based product/system and both the water diversion and water collection applications fulfill the consumer needs for water run-off and water irrigation use. Features from this product/system offer safe and efficient applications to address water over-flow and addition water storage applications.

### BRIEF DESCRIPTION OF THE DRAWINGS

Figure One provides the top, front, and side views demonstrating the water intake port and water exit port layouts.

Figure Two provides a perspective/exploded view of the complete assembly of the water diversion product/system, and the water collection product/system.

Figure Three provides the top, front, and side views in an exploded diagram of the water diversion product/system, and the water collection product/system as an open water intake version of the system.

### THE PRODUCT DESCRIPTION

In Figure One, the water diverter/collector system flow diagram details the collection and water-flow process. The water intake (A) is from the main water intake source (downspout, gutter, hose, etc.). The ground support for the water diverter product/system (B) is the grounding/anchoring feature to the ground near the main water intake source (downspout, gutter, hose, etc.). The water exit/intake for the water collector product/system (B) is the outside water intake/collection source (tank, storage unit, container, etc.). The water outlet to landscape for both the water diverter product/system and the water collector product/system assemblies (C) is for water over-flow and additional capacity storage applications. Figures Two and Three also show this diagram.

In Figure Two, the water diverter/collector system consists of the main housing body (1), to be assembled to the main housing cover/lid (2), for collecting water for diversion and collection to outside water use applications and sources. An adaptive water intake feature (3) is geometrically integrated into the water intake opening of the main housing cover/lid (2). The adaptive connector/units as the connecting feature(s) for the water exit port/system (4), are connected to the system integrated dimensional geometry and features of the water exit port/system(s) (5), of the system integrated dimensional geometry and features of the main housing body (1).

The assembled product/version of the as a water diverter product/system has the assembled main housing body (1) and main housing cover/lid (2), positioned accordingly to the water intake source (downspout, gutter, hose, etc.). The adaptive connector/units as the connecting feature(s) (hoses, tubing, etc.) for the water exit port/system (4) are assembled to the system integrated dimensional geometry and features of the water exit port/system(s) (5), of the system integrated dimensional geometry and features of the main housing body (1). The adaptive water intake feature (3) of the main housing cover/lid (2) assembles to an outside adaptive connector/unit (6) that will attach to a connecting device from the water intake source.

The assembled product/version of the as a water collector product/system has the system integrated dimensional geometry and features of the bottom side water exit port (7) of the main housing body (1) assembled to the outside water intake/collection source (tank, storage unit, container, etc.) (8). The main housing cover/lid (2) is then assembled to the main housing body (1). A single-use application of the water collector product/system uses all water exit port connecting systems (4), as a water over-flow application to distribute non-collected water from full capacity containment systems away from the initial water intake/collection source (tank, storage unit, container, etc.)(8), and nearby structural features. The adaptive connector/units as the connecting feature(s) (hoses, tubing, etc.) for the water exit port/system (4) are then assembled to the system integrated dimensional geometry and features of the water exit port/system(s) (5), of the system integrated dimensional geometry and features of the main housing body (1). The adaptive water intake feature (3) of the main housing cover/lid (2) then assembles to the outside adaptive connector/unit (6) that attaches to a connecting device from the water intake source (downspout, gutter, hose, etc.).

When a multiple outside water intake/collection source application (tank, storage unit, container, etc.) (8) for additional capacity is used, one end of the adaptive connector/units as the connecting feature(s) (hoses, tubing, etc.) for the water exit port/system (4) serves as the connection for the additional capacity source. The water over-flow/capacity adapter (9) is assembled to a single selected end of the system integrated dimensional geometry and features of the water exit port/system(s) (5), of the system integrated dimensional geometry and features of the main housing body (1), opposite the additional capacity connection.

Additional water capacity applications for both the water diverter product/system and the water collector product/system assemblies require the additional capacity cover/lid adapter (10), to be assembled to the open feature of the adaptive water intake feature (3) of the main housing cover/lid (2), when no outside adaptive connector/unit (6) is used with the multiple outside water intake/collection source application. The cover/lid adapter (10), is also used for assembly to the inside water collector opening of the main housing cover/lid (2), when the unit is used for water diversion instead of water collection on a tank application. Two plugs (11) are inserted into the two mounting holes from the water collection/tank mount application.

In Figure Three, the water diverter/collector system shows an open water intake version with the main housing body (1) assembled to the outside water intake/collection source (tank, storage unit, container, etc.) (8). The assembled product/version of the as a water collector product/system has the system integrated dimensional geometry and features of the bottom side water exit port (7) of the main housing body (1) assembled to the outside water intake/collection source (tank, storage unit, container, etc.) (8). A protective screen (12) is assembled to the inside of the open intake version of the main housing body (1).

The adaptive connector/units as the connecting feature(s) for the water exit port/system (4), are connected to the system integrated dimensional geometry and features of the water exit port/system(s) (5), of the system integrated dimensional geometry and features of the main housing body (1). When a multiple outside water intake/collection source application (tank, storage unit, container, etc.) (8) for additional capacity is used, one end of the adaptive connector/units as the connecting feature(s) (hoses, tubing, etc.) for the water exit port/system (4) serves as the connection for the additional capacity source. The water over-flow/capacity adapter (9) is assembled to a single selected end of the system integrated dimensional geometry and features of the water exit port/system(s) (5), of the system integrated dimensional geometry and features of the main housing body (1), opposite the additional capacity connection.

What is claimed is:

1. A single-based product/system and both the water diversion and water collection applications comprising of:
a. A main housing body defining:
i. A containment body to collect water from an intake port from an outside water source.
ii. Multiple exit ports to distribute the water to outside sources for water diversion and water collection applications.
b. An optional exit port and mounting feature(s) for securing the main housing body to an outside containment product/system for use with the water transfer and use with collection/storage applications.
c. The bottom side of the optional exit port rib/feature is used with the water diversion product/system as an anchoring device to fix the position of the assembled unit to the ground when positioned to outside water intake source and the water exit arrangements.
d. The bottom side of the optional exit port is modified to open a clearance hole within the exit port rib/feature and add mounting holes for securing the main housing body to an outside containment product/system for use with water transfer and use with collection/storage applications.
e. The top side of the main housing body is open for access/clearance to the optional exit port and mounting feature(s) for securing the main housing body to an outside containment product/system for use with water transfer and use with water collection/storage applications.
f. A main housing cover/lid as a secured and mounted containment feature assembled to the main housing body defining:
i. An integrated water intake port for water diversion and water collection applications.
g. The secured containment assembly of the main housing body and main housing cover/lid to prevent outside contaminants and foreign bodies from becoming a host with the still water within the assembled and captive water product/system.

2. The multiple water exit port/system according to claim 1, wherein the main housing body serves as the multiple water exit port/system comprising of:
a. The multiple water exit port/system integrated dimensional geometry and features as part of the main housing body.
b. The use of outside adaptive connector/units that assemble to the outside exit port/systems of the main housing body defining:
i. The outside adaptive connector/units as the connecting feature for the transfer of water for over-flow applications.
ii. The outside adaptive connector/units as the connecting feature for the transfer of water for collection/storage applications
c. The water intake port/system according to claim 1, wherein the main housing cover/lid serves as the water intake port.
d. The intake port/system integrated dimensional geometry and features as part of the main housing cover/lid.
e. The use of an outside adaptive connector/unit that assembles to the top of the intake port/system of the main housing cover/lid defining:
i. The outside adaptive connector/unit as the connecting feature with the outside water intake/collection source.
f. A water over-flow/capacity housing/adapter to partially obstruct water flow through one of the exit port/system features integrated into the main housing body according to claim 1, defining:
i. The captivity of intake water at the designated over-flow port for the transportation of the same intake water to remaining exit ports to secondary outside collection/storage sources assembled for additional capacity of collected intake water.
ii. The transportation of captive intake water from a full-capacity collection system through the designated over-flow port using the assembled overflow capacity adapter.
iii. The transportation of over-flow water through the outside adaptive connector/unit(s) assembled to the exit port using the water over-flow capacity adapter.
iv. The transportation of over-flow water through the outside adaptive connector/unit(s) away from the collection/storage system and nearby structural features.
g. An additional capacity cover/lid adapter housing that assembles into the main using cover/lid intake port according to claim 1, defining:
i. The additional capacity cover/lid adapter integrated dimensional geometry and features assemble into the water intake port.
ii. The additional capacity cover/lid adapter used as a protective enclosure for the main housing water diverter assembly as an additional capacity application.
iii. The additional capacity cover/lid adapter used as a protective enclosure for the main housing water collector assembly as an additional capacity application.
iv. The additional capacity cover/lid adapter used as a protective enclosure for the main housing water collector assembly as a containment lid to the water collector opening, to be converted to a water diversion application (no water collector tank).
h. The secured containment assembly of the main housing body and main housing cover/lid, with the additional capacity cover/lid adapter, wherein to prevent outside contaminants and foreign bodies from becoming a host with the still water within the assembled and captive water product/system.
i. The water diversion product/system and main housing body according to claim 1 and the assembled main housing cover/lid according to claim 1, wherein the unit collects water from an intake port/system from an outside water intake source.
j. The water exit port/system according to claim 1, wherein the outside adaptive connector/units as the connecting feature(s) transfer intake water to outside sources for run-off diversion and/or water irrigation applications.
k. The additional capacity cover/lid adapter wherein the cover/lid adapter is used as a protective enclosure for the main housing water diverter assembly as an additional capacity application.
l. The additional capacity cover/lid adapter used as a protective enclosure for the main housing water collector assembly as a containment lid to the water collector opening, to be converted to a water diversion application (no water collector tank).
m. The secured containment assembly of the main housing body and main housing cover/lid, with the additional capacity cover/lid adapter wherein to prevent outside contaminants and foreign bodies from becoming a host with the still water within the assembled and captive water product/system.
n. The bottom side of the optional exit port rib/feature according to claim 1, wherein it is used with the water diversion product/system as an anchoring device to fix the position of the assembled unit to the ground when positioned to outside water intake source and the water exit arrangements.
o. The water collection product/system and main housing body according to claim 1 and the assembled main housing cover/lid according to claim 1, wherein the unit collects water from an intake port/system from an outside water intake source.
p. The main housing body according to claim 1, wherein the bottom side of the claimed unit optional exit port and mounting feature(s) is open for securing the housing body to an outside containment product/system for use with the water transfer and use with collection/storage applications.
q. The water exit port/system according to claim 1, wherein the outside adaptive connector/units as the connecting feature(s) transfer intake water to outside sources for run-off diversion and/or water irrigation applications.
r. The water over-flow/capacity adapter according, wherein the water intake is obstructed at the over-flow exit, then diverted to the additional capacity outside collection/storage sources.
s. The exit port additional capacity connector, where the captivity of intake water at the designated over-flow port for the transportation of the same intake water to remaining exit ports to secondary outside additional capacity is received for collection/storage sources assembled for additional capacity of collected intake water.
t. The water over-flow/capacity adapter, wherein the captive intake water from a fully captive system is first transferred to the designated water over-flow exit port.
u. The additional capacity cover/lid adapter, wherein the cover/lid adapter is used as a protective enclosure for the main housing water collector assembly as an additional capacity application.
v. The bottom side of the optional exit port according to claim 1, wherein the optional exit port and mounting feature(s) are secured to the main housing body to an outside containment product/system for use with water transfer for water collection/storage applications.
w. The secured containment assembly of the main housing body and main housing cover/lid, with the additional capacity cover/lid adapter, wherein to prevent outside contaminants and foreign bodies from becoming a host with the still water within the assembled and captive water product/system.

3. The water collection product/system and application as an open water intake version comprising of:
a. The main housing body according to claim 1 and the assembled main housing cover/lid according to claim 1, wherein the unit collects water from an intake port/system according to claim 2 from an outside water intake source.
b. The main housing body according to claim 1, wherein the bottom side of the claimed unit optional exit port and mounting feature(s) is open for securing the housing body to an outside containment product/system for use with the water transfer and use with collection/storage applications.
c. The water exit port/system according to claim 1, wherein the outside adaptive connector/units as the connecting feature(s) according to claim 2 transfer intake water to outside sources for run-off diversion and/or water irrigation applications.
d. The water over-flow/capacity adapter according to claim 2, wherein the water intake is obstructed at the over-flow exit, then diverted to the additional capacity outside collection/storage sources.
e. The exit port additional capacity connector, where the captivity of intake water at the designated over-flow port for the transportation of the same intake water to remaining exit ports to secondary outside additional capacity is received for collection/storage sources assembled for additional capacity of collected intake water.
f. The water over-flow/capacity adapter according to claim 2, wherein the captive intake water from a fully captive system is first transferred to the designated water over-flow exit port.
g. The bottom side of the optional exit port according to claim 1, wherein the optional exit port and mounting feature(s) are secured to the main housing body to an outside containment product/system for use with water transfer for water collection/storage applications.
h. A protective screen that is assembled to the inside of the open intake version of the main housing body.
